(19) United States
(12) Patent Application Publication
(10) Pub. No.: US 2026/0322470 A1
(43) Pub. Date: Oct. 15, 2026

(54) POLARIZATION TRAINING FOR MOVEABLE ANTENNA PANELS

(71) Applicant: QUALCOMM Incorporated, San Diego, CA (US)

(72) Inventors: Vasanthan RAGHAVAN, West Windsor Township, NJ (US); Jung Ho RYU, Englewood Cliffs, NJ (US)

(21) Appl. No.: 19/179,707

(22) Filed: Apr. 15, 2025

(51) Int. Cl. H04B 7/06; H01Q 19/13; H04B 7/0404; H04W 24/10

(52) U.S. Cl. CPC H04B 7/06956; H01Q 19/136; H04B 7/0404; H04W 24/10

(57) ABSTRACT

Various aspects of the present disclosure generally relate to wireless communication. In some aspects, a wireless device may receive a set of reference signals corresponding to a set of positions of a first antenna panel of the wireless device relative to a second antenna panel of the wireless device. The wireless device may obtain a set of measurements on the set of reference signals in response to a polarization imbalance between the first antenna panel and the second antenna panel satisfying a polarization training threshold, the polarization imbalance based on a downlink reference signal. The wireless device may communicate, with a network node, using a selected position from the set of positions, where the selected position is determined using the set of measurements. Numerous other aspects are described.

### FIELD OF THE DISCLOSURE

Aspects of the present disclosure generally relate to wireless communication and specifically relate to techniques, apparatuses, and methods associated with polarization training for moveable antenna panels.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless devices (also referred to as “customer premises equipment” or “CPEs”) may include smaller antenna arrays. To improve gain, the wireless devices may further include a reflector (e.g., a Cassegrain reflector) as well as a motor (e.g., a mechanical rotator) to allow the smaller antenna arrays to move. As a result, the wireless devices may move the smaller antenna arrays to locations associated with greater signal strength.

### SUMMARY

A wireless device may include multiple antenna panels (e.g., a first antenna panel and a second antenna panel) that are moveable (e.g., relative to each other). Accordingly, the antenna panels may experience polarization imbalance that attenuates a wireless signal at one antenna panel more than another antenna panel. Attenuation due to polarization imbalance may be in addition to signal strength differences caused by a channel environment around the wireless device.

Various aspects relate generally to polarization training of antenna panels (e.g., a first antenna panel and a second antenna panel) of a wireless device using a set of measurements on a set of reference signals. In some aspects, the wireless device may transmit a report indicating polarization imbalance (e.g., polarization imbalance on a downlink channel) to a network, and the network may transmit a configuration for the set of reference signals in response to the report. Therefore, the wireless device may measure the set of reference signals across different positions of the antenna panels in order to select a position that reduces the polarization imbalance. Alternatively, the network may detect polarization imbalance (e.g., on an uplink channel) and may transmit the configuration for the set of reference signals in response to detecting the polarization imbalance. Therefore, the wireless device may report measurements of the set of reference signals, across different positions of the antenna panels, to the network so that the network may select a position that reduces the polarization imbalance.

The systems, methods, and devices of this disclosure each have several innovative aspects, no single one of which is solely responsible for the desirable attributes disclosed herein.

Some aspects described herein relate to a method of wireless communication performed by a wireless device. The method may include receiving a set of reference signals corresponding to a set of positions of a first antenna panel of the wireless device relative to a second antenna panel of the wireless device. The method may include obtaining a set of measurements on the set of reference signals in response to a polarization imbalance between the first antenna panel and the second antenna panel satisfying a polarization training threshold, the polarization imbalance based on a downlink reference signal. The method may include communicating, with a network node, using a selected position from the set of positions, wherein the selected position is determined using the set of measurements.

Some aspects described herein relate to a method of wireless communication performed by a UE. The method may include transmitting a report indicating a polarization imbalance between a first antenna panel of the UE and a second antenna panel of the UE, wherein the first antenna panel and the second antenna panel are moveable relative to each other. The method may include receiving, in response to the report, a configuration for a set of downlink reference signals to measure. The method may include performing a set of measurements on the set of downlink reference signals, wherein the set of measurements are used to determine a selected position for the first antenna panel and the second antenna panel.

Some aspects described herein relate to a method of wireless communication performed by a network node. The method may include receiving a report indicating a polarization imbalance between a first antenna panel of a UE and a second antenna panel of the UE, wherein the first antenna panel and the second antenna panel are moveable relative to each other. The method may include transmitting, in response to the report, a configuration for a set of downlink reference signals. The method may include transmitting the set of downlink reference signals for measurement by the UE to determine a selected position for the first antenna panel and the second antenna panel.

Some aspects described herein relate to a wireless device. The wireless device may include a first antenna panel, a second antenna panel, and a processing system. The processing system may include one or more processors and one or more code-storing memories coupled with the one or more processors. The processing system may be configured to cause the wireless device to receive a set of reference signals corresponding to a set of positions of the first antenna panel relative to the second antenna panel. The processing system may be configured to cause the wireless device to obtain a set of measurements on the set of reference signals in response to a polarization imbalance between the first antenna panel and the second antenna panel satisfying a polarization training threshold, the polarization imbalance based on a downlink reference signal. The processing system may be configured to cause the wireless device to communicate, with a network node, using a selected position from the set of positions, wherein the selected position is determined using the set of measurements.

Some aspects described herein relate to a UE. The UE may include a processing system. The processing system may include one or more processors and one or more code-storing memories coupled with the one or more processors. The processing system may be configured to cause the UE to transmit a report indicating a polarization imbalance between a first antenna panel of the UE and a second antenna panel of the UE, wherein the first antenna panel and the second antenna panel are moveable relative to each other. The processing system may be configured to cause the UE to receive, in response to the report, a configuration for a set of downlink reference signals to measure. The processing system may be configured to cause the UE to perform a set of measurements on the set of downlink reference signals, wherein the set of measurements are used to determine a selected position for the first antenna panel and the second antenna panel.

Some aspects described herein relate to a network node. The network node may include a processing system. The processing system may include one or more processors and one or more code-storing memories coupled with the one or more processors. The processing system may be configured to cause the network node to receive a report indicating a polarization imbalance between a first antenna panel of a UE and a second antenna panel of the UE, wherein the first antenna panel and the second antenna panel are moveable relative to each other. The processing system may be configured to cause the network node to transmit, in response to the report, a configuration for a set of downlink reference signals. The processing system may be configured to cause the network node to transmit the set of downlink reference signals for measurement by the UE to determine a selected position for the first antenna panel and the second antenna panel.

Some aspects described herein relate to a non-transitory computer-readable medium that stores a set of instructions for wireless communication by a wireless device. The set of instructions, when executed by one or more processors of the wireless device, may cause the wireless device to receive a set of reference signals corresponding to a set of positions of a first antenna panel of the wireless device relative to a second antenna panel of the wireless device. The set of instructions, when executed by one or more processors of the wireless device, may cause the wireless device to obtain a set of measurements on the set of reference signals in response to a polarization imbalance between the first antenna panel and the second antenna panel satisfying a polarization training threshold, the polarization imbalance based on a downlink reference signal. The set of instructions, when executed by one or more processors of the wireless device, may cause the wireless device to communicate, with a network node, using a selected position from the set of positions, wherein the selected position is determined using the set of measurements.

Some aspects described herein relate to a non-transitory computer-readable medium that stores a set of instructions for wireless communication by a UE. The set of instructions, when executed by one or more processors of the UE, may cause the UE to transmit a report indicating a polarization imbalance between a first antenna panel of the UE and a second antenna panel of the UE, wherein the first antenna panel and the second antenna panel are moveable relative to each other. The set of instructions, when executed by one or more processors of the UE, may cause the UE to receive, in response to the report, a configuration for a set of downlink reference signals to measure. The set of instructions, when executed by one or more processors of the UE, may cause the UE to perform a set of measurements on the set of downlink reference signals, wherein the set of measurements are used to determine a selected position for the first antenna panel and the second antenna panel.

Some aspects described herein relate to a non-transitory computer-readable medium that stores a set of instructions for wireless communication by a network node. The set of instructions, when executed by one or more processors of the network node, may cause the network node to receive a report indicating a polarization imbalance between a first antenna panel of a UE and a second antenna panel of the UE, wherein the first antenna panel and the second antenna panel are moveable relative to each other. The set of instructions, when executed by one or more processors of the network node, may cause the network node to transmit, in response to the report, a configuration for a set of downlink reference signals. The set of instructions, when executed by one or more processors of the network node, may cause the network node to transmit the set of downlink reference signals for measurement by the UE to determine a selected position for the first antenna panel and the second antenna panel.

Some aspects described herein relate to an apparatus for wireless communication. The apparatus may include means for receiving a set of reference signals corresponding to a set of positions of a first antenna panel of the apparatus relative to a second antenna panel of the apparatus. The apparatus may include means for obtaining a set of measurements on the set of reference signals in response to a polarization imbalance between the first antenna panel and the second antenna panel satisfying a polarization training threshold, the polarization imbalance based on a downlink reference signal. The apparatus may include means for communicating, with a network node, using a selected position from the set of positions, wherein the selected position is determined using the set of measurements.

Some aspects described herein relate to an apparatus for wireless communication. The apparatus may include means for transmitting a report indicating a polarization imbalance between a first antenna panel of the apparatus and a second antenna panel of the apparatus, wherein the first antenna panel and the second antenna panel are moveable relative to each other. The apparatus may include means for receiving, in response to the report, a configuration for a set of downlink reference signals to measure. The apparatus may include means for performing a set of measurements on the set of downlink reference signals, wherein the set of measurements are used to determine a selected position for the first antenna panel and the second antenna panel.

Some aspects described herein relate to an apparatus for wireless communication. The apparatus may include means for receiving a report indicating a polarization imbalance between a first antenna panel of a UE and a second antenna panel of the UE, wherein the first antenna panel and the second antenna panel are moveable relative to each other. The apparatus may include means for transmitting, in response to the report, a configuration for a set of downlink reference signals. The apparatus may include means for transmitting the set of downlink reference signals for measurement by the UE to determine a selected position for the first antenna panel and the second antenna panel.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2A is a diagram illustrating examples of electromagnetic polarization.

FIG. 2B is a diagram illustrating an example of a customer premises equipment with a moveable antenna array and a reflector.

FIGS. 3A, 3B, and 3C are diagrams illustrating examples associated with moveable antenna arrays.

FIGS. 4A and 4B are diagrams illustrating examples associated with polarization training for moveable antenna arrays.

FIG. 5 is a diagram illustrating an example process performed, for example, by a wireless device.

FIG. 6 is a diagram illustrating an example process performed, for example, by a user equipment.

FIG. 7 is a diagram illustrating an example process performed, for example, by a network node.

FIGS. 8 and 9 are diagrams of example apparatuses for wireless communication.

### DETAILED DESCRIPTION

To reduce cost and size, a wireless device, such as a customer premises equipment (CPE) operating at millimeter wave frequencies (e.g., 28 or 39 gigahertz (GHz)), may include a smaller antenna array (e.g., smaller than a 16×16 array of antenna elements or smaller than an 8×8 array of antenna elements). In order to improve gain, the wireless device may include a reflector (e.g., a Cassegrain reflector) that concentrates energy from the smaller antenna array into a narrower beamwidth. Additionally, the wireless device may include a motor (e.g., a mechanical rotator or actuator) configured to move the smaller antenna array. As a result, the wireless device may move the smaller antenna array to locations associated with greater signal strength.

In some cases, the smaller antenna array may be divided, physically, across different antenna panels. Therefore, one or more motors of the wireless device may move the antenna panels relative to each other. In addition, due to different antenna panels experiencing different signal strengths due to environmental factors, incident electromagnetic waves (e.g., radio frequency (RF) signals from a network) may arrive at different antenna panels with different polarizations. Because signal strength is attenuated by a mismatch between polarization of a receiving antenna panel and polarization of an incident wave, different antenna panels may experience different attenuations for a signal transmitted with a same polarization (e.g., from a network).

Various aspects relate generally to polarization training of antenna panels of a wireless device using a set of measurements on a set of reference signals. Some aspects more specifically relate to the wireless device transmitting a report indicating polarization imbalance (e.g., on a downlink channel) to a network, and the network transmitting a configuration for the set of reference signals in response to the report. Alternatively, the network may detect polarization imbalance (e.g., on an uplink channel) and may transmit the configuration for the set of reference signals in response to detecting the polarization imbalance.

Particular aspects of the subject matter described in this disclosure can be implemented to realize one or more of the following potential advantages. In some examples, the described techniques can be used to improve quality and reliability of communications at the wireless device. As a result, the wireless device can conserve power and processing resources that otherwise would have been spent on retransmissions (e.g., due to lost signals and data). In some examples, the described techniques can be used to improve quality and reliability of communications at the network. Therefore, the network similarly conserves power and processing resources that otherwise would have been spent on retransmissions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

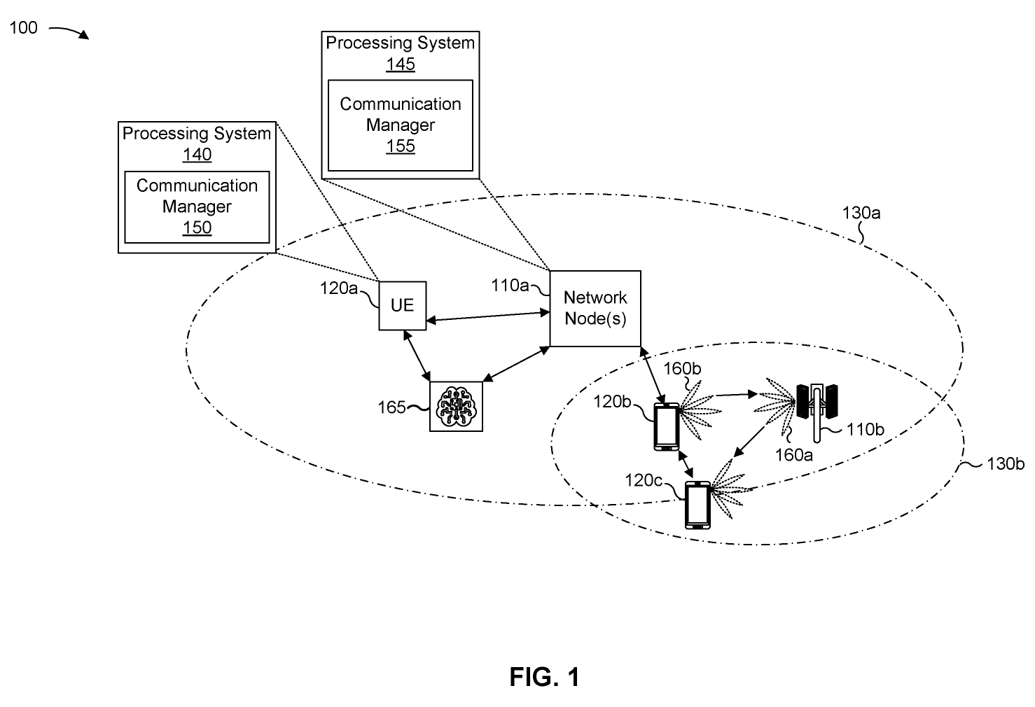

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a wireless device (e.g., the UE 120) may include a processing system 140 with a communication manager 150. As described in more detail elsewhere herein, the communication manager 150 may receive a set of reference signals corresponding to a set of positions of a first antenna panel of the wireless device relative to a second antenna panel of the wireless device; may obtain a set of measurements on the set of reference signals in response to a polarization imbalance between the first antenna panel and the second antenna panel satisfying a polarization training threshold, the polarization imbalance based on a downlink reference signal; and may communicate (e.g., with the network node 110) using a selected position from the set of positions, where the selected position is determined using the set of measurements. Additionally, or alternatively, as described in more detail elsewhere herein, the communication manager 150 may transmit a report indicating a polarization imbalance between a first antenna panel of the wireless device and a second antenna panel of the wireless device, where the first antenna panel and the second antenna panel are moveable relative to each other; may receive, in response to the report, a configuration for a set of downlink reference signals to measure; and may perform a set of measurements on the set of downlink reference signals, where the set of measurements are used to determine a selected position for the first antenna panel and the second antenna panel. Additionally, or alternatively, the communication manager 150 may perform one or more other operations described herein.

In some aspects, the network node 110 may include a processing system 145 with a communication manager 155. As described in more detail elsewhere herein, the communication manager 155 may receive a report indicating a polarization imbalance between a first antenna panel of the UE 120 and a second antenna panel of the UE 120, where the first antenna panel and the second antenna panel are moveable relative to each other; may transmit, in response to the report, a configuration for a set of downlink reference signals; and may transmit the set of downlink reference signals for measurement by the UE 120 to determine a selected position for the first antenna panel and the second antenna panel. Additionally, or alternatively, the communication manager 155 may perform one or more other operations described herein.

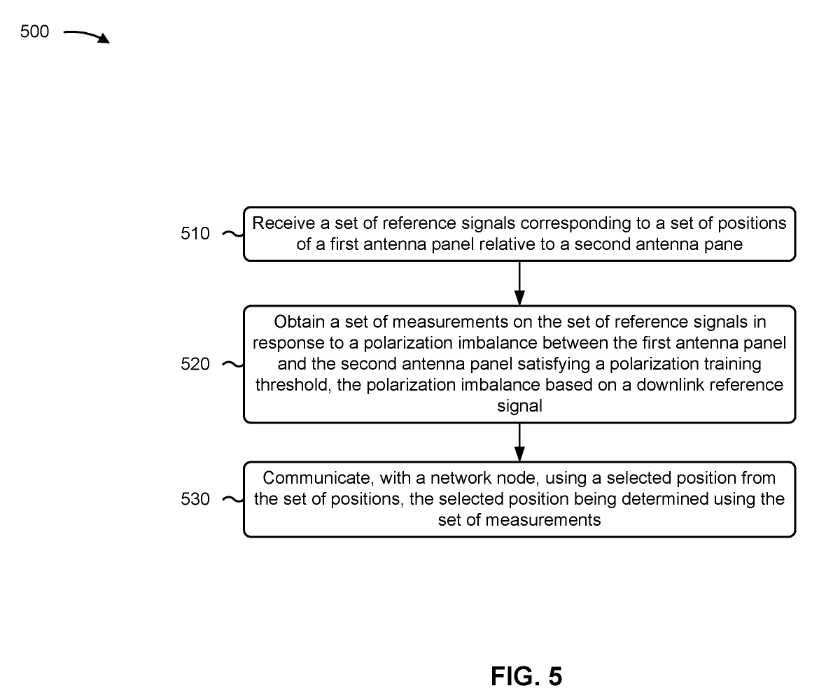

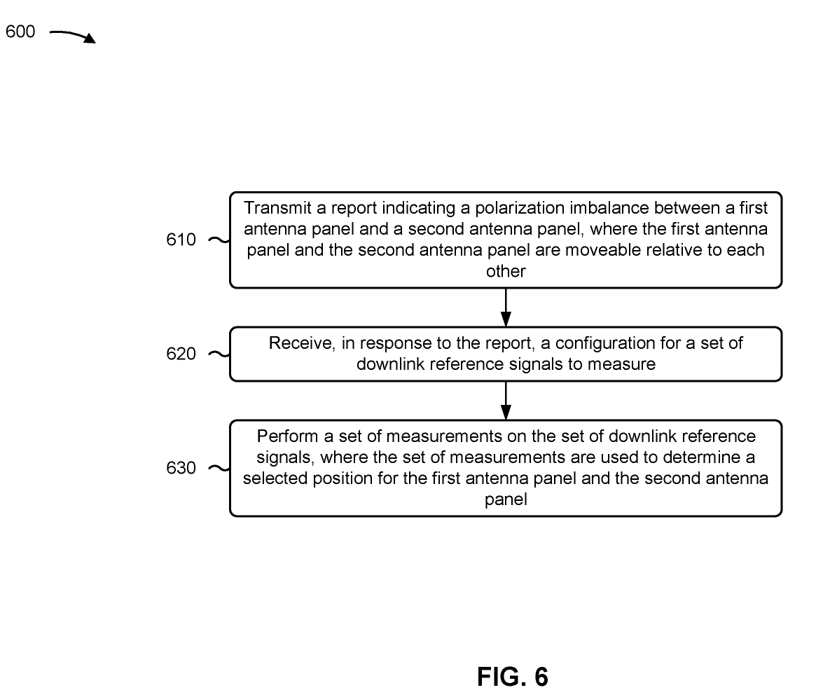

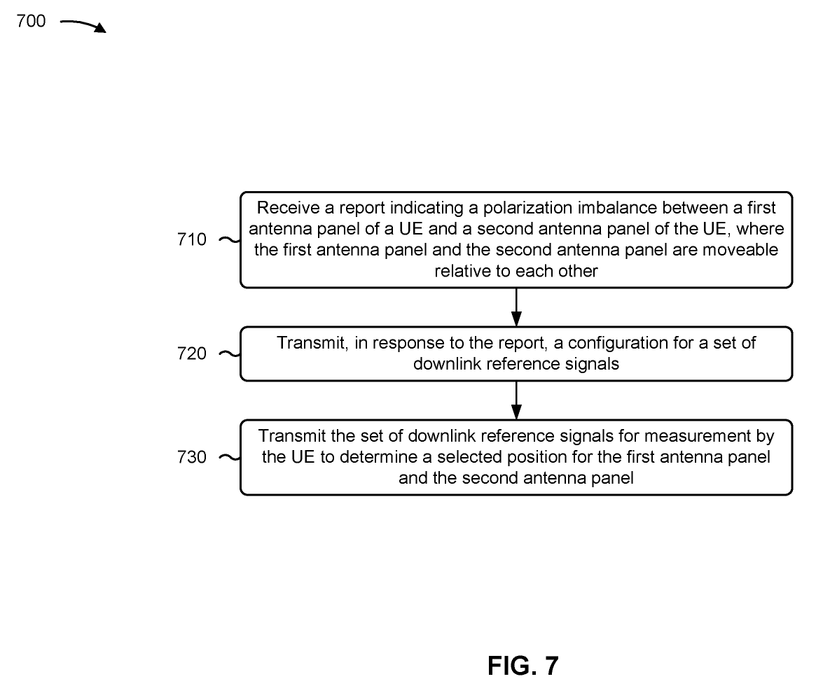

The network node 110, the processing system 145 of the network node 110, the UE 120, the processing system 140 of the UE 120, or any other component(s) of FIG. 1 may implement one or more techniques or perform one or more operations associated with polarization training for moveable antenna panels, as described in more detail elsewhere herein. For example, the processing system 145 of the network node 110, or the processing system 140 of the UE 120 may perform or direct operations of, for example, process 500 of FIG. 5, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, process 700 of FIG. 7, or other processes as described herein. In some examples, executing instructions may include running the instructions, converting the instructions, compiling the instructions, or interpreting the instructions, among other examples.

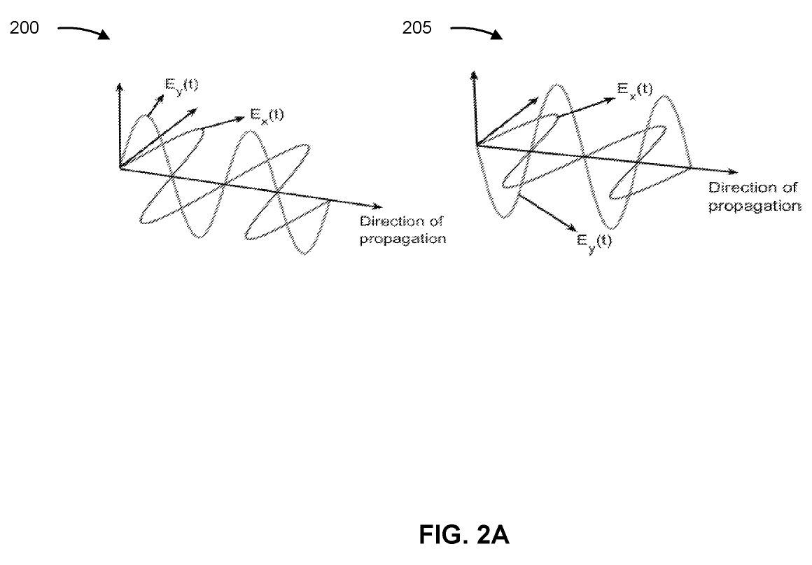

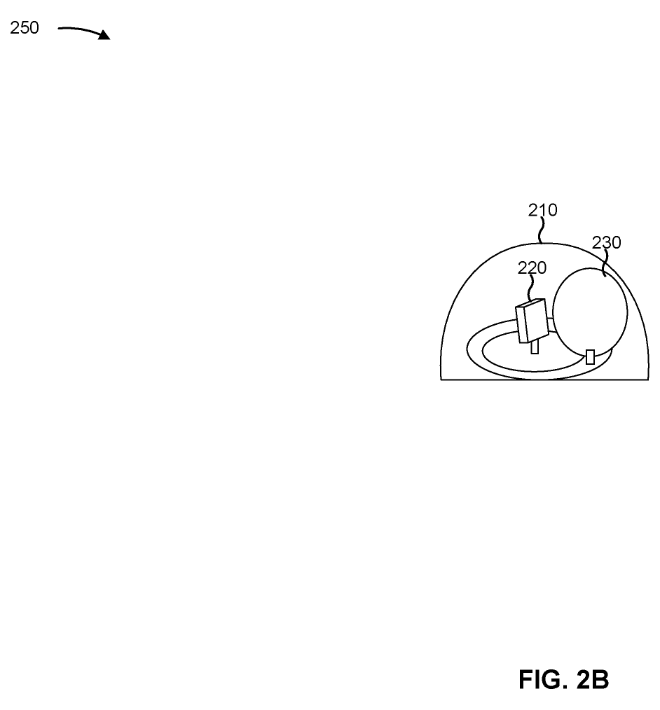

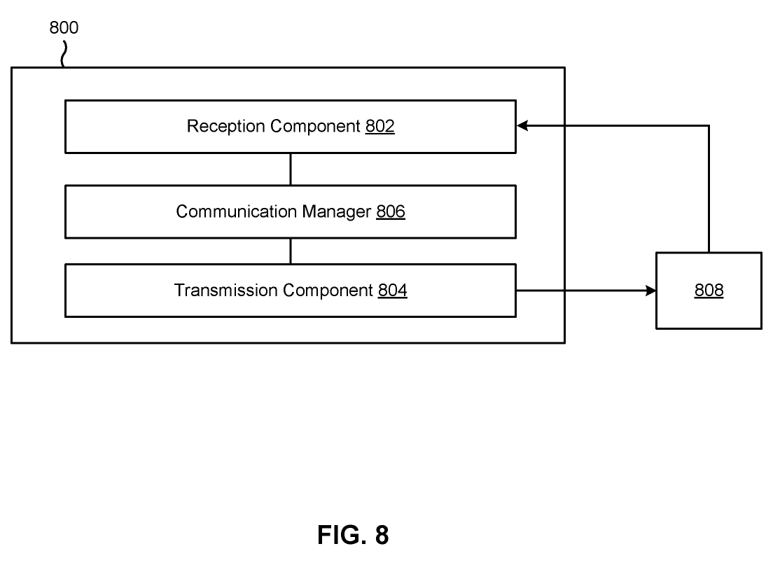

In some aspects, a wireless device (e.g., the UE 120, a CPE 210 of FIG. 2B, or apparatus 800 of FIG. 8) may include means for receiving a set of reference signals corresponding to a set of positions of a first antenna panel of the wireless device relative to a second antenna panel of the wireless device; means for obtaining a set of measurements on the set of reference signals in response to a polarization imbalance between the first antenna panel and the second antenna panel satisfying a polarization training threshold, the polarization imbalance based on a downlink reference signal; and means for communicating, with a network node, using a selected position from the set of positions, wherein the selected position is determined using the set of measurements. Additionally, or alternatively, the wireless device may include means for transmitting a report indicating a polarization imbalance between a first antenna panel of the wireless device and a second antenna panel of the wireless device, wherein the first antenna panel and the second antenna panel are moveable relative to each other; means for receiving, in response to the report, a configuration for a set of downlink reference signals to measure; and means for performing a set of measurements on the set of downlink reference signals, wherein the set of measurements are used to determine a selected position for the first antenna panel and the second antenna panel. In some aspects, the means for the wireless device to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

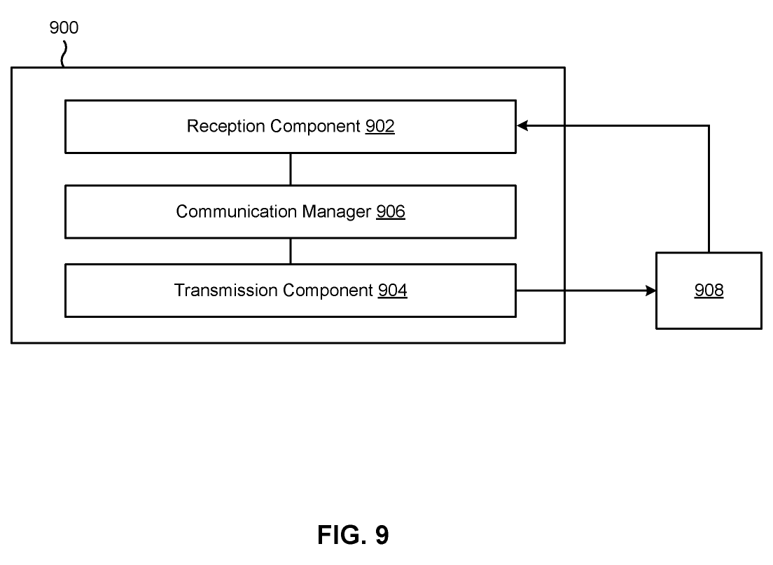

In some aspects, a network node (e.g., the network node 110, an RU, a DU, a CU, or apparatus 900 of FIG. 9) may include means for receiving a report indicating a polarization imbalance between a first antenna panel of a wireless device (e.g., the UE 120, the CPE 210 of FIG. 2B, or apparatus 800 of FIG. 8) and a second antenna panel of the wireless device, wherein the first antenna panel and the second antenna panel are moveable relative to each other; means for transmitting, in response to the report, a configuration for a set of downlink reference signals; and means for transmitting the set of downlink reference signals for measurement by the wireless device to determine a selected position for the first antenna panel and the second antenna panel. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

FIG. 2A is a diagram illustrating an example 200 of positive polarization and an example 205 of negative polarization. An electromagnetic wave generally is characterized by an electric field vector, a magnetic field vector, and a direction of propagation, all three of which are orthogonal to each other. Examples 200 and 250 show the electric field components Eₓ(t) and E_{y}(t) of a linearly polarized electromagnetic wave. The wave in the example 200 is positively phased while the wave in the example 250 is negatively phased.

In FIG. 2A, the locus of the electric field is a straight line, but other examples may include a circle or an ellipse as the locus of the electric field (e.g., such that Eₓ(t) and E_{y}(t) exhibit an angular gap). Accordingly, an electromagnetic wave may be circularly or elliptically polarized rather than linearly polarized.

In one example of a polarized system, the slope of the locus may be 0^{o} (also referred to as a horizontally polarized system) or 90^{o} (also referred to as a vertically polarized system). In another example of a polarized system, the slope of the locus may be 45^{o} (also referred to as a V polarization) or -45^{o} (also referred to as H polarization). An antenna panel may include antenna elements of different polarizations to increase performance.

FIG. 2B is a diagram illustrating an example 250 of a CPE with a moveable antenna array and a reflector. As shown in FIG. 2B, example 250 includes a CPE 210. The CPE 210 may be a UE or another type of wireless device. The CPE 210 may include an antenna panel 220 that is moveable. For example, the antenna panel 220 may be connected to a rotational motor, such that the antenna panel 220 may rotate around an axis of the CPE 210.

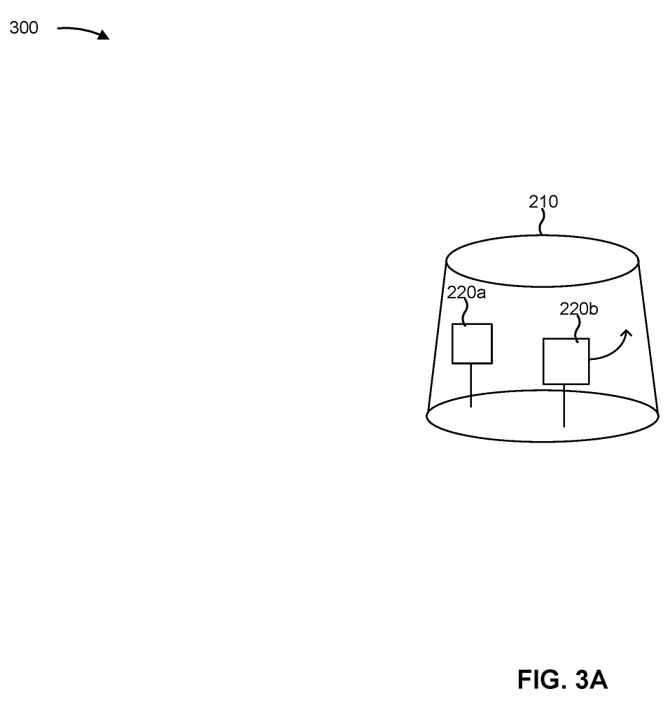

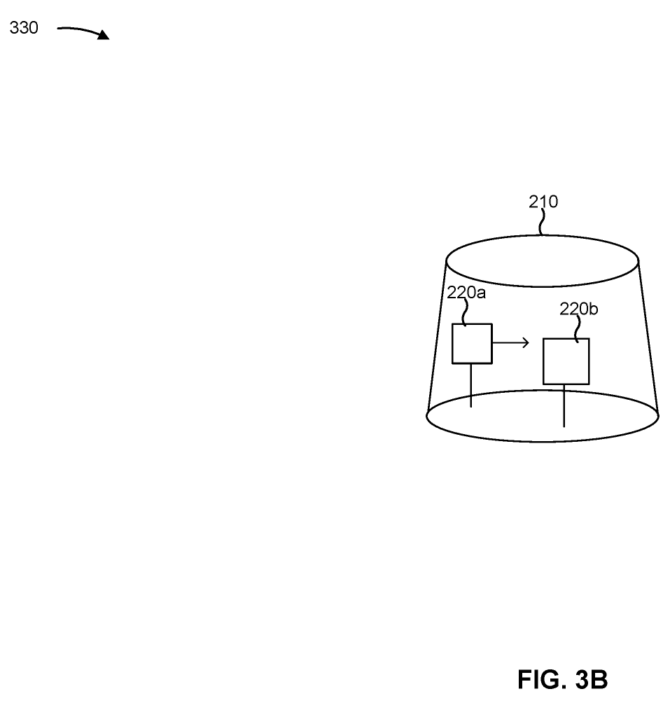

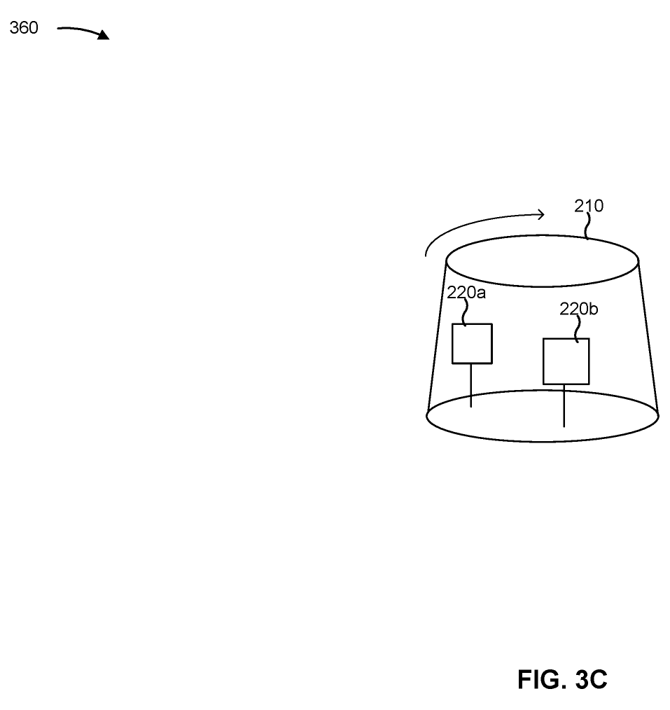

Additionally, the CPE 210 may include a reflector 230 that is moveable. For example, the reflector 230 may be connected to a rotatable base, such that the reflector 230 may rotate along an orbit of the CPE 210. In order to further increase quality and reliability at the CPE 210, additional antenna panels may be included, as described in connection with FIGS. 3A-3C.

As indicated above, FIGS. 2A-2B are provided as examples. Other examples may differ from what is described with respect to FIGS. 2A-2B.

FIGS. 3A, 3B, and 3C are diagrams illustrating examples 300, 330, and 360, respectively, associated with moveable antenna arrays. As shown in FIG. 3A, example 300 includes a CPE 210. The CPE 210 may be a UE or another type of wireless device. The CPE 210 may include a first antenna panel 220a and a second antenna panel 220b. Other examples may include additional antenna panels.

As further shown in FIG. 3A, at least one of the antenna panels (e.g., the second antenna panel 220b in the example 300) is moveable relative to the other antenna panels (e.g., the first antenna panel 220a in the example 300). In FIG. 3A, the second antenna panel 220b may be rotated (e.g., using a rotational motor) relative to the first antenna panel 220a. Therefore, the CPE 210 may move between different positions of the antenna panels 220a and 220b by rotating the second antenna panel 220b.

As shown in FIG. 3B, example 330 includes a CPE 210. The CPE 210 may be a UE or another type of wireless device. The CPE 210 may include a first antenna panel 220a and a second antenna panel 220b. Other examples may include additional antenna panels.

As further shown in FIG. 3B, at least one of the antenna panels (e.g., the first antenna panel 220a in the example 330) is moveable relative to the other antenna panels (e.g., the second antenna panel 220b in the example 330). In FIG. 3B, the first antenna panel 220a may be translated (e.g., using a linear motor) relative to the second antenna panel 220b. Therefore, the CPE 210 may move between different positions of the antenna panels 220a and 220b by translating the first antenna panel 220a.

Example 330 may be combined with example 300. For example, the first antenna panel 220a may be translatable, and the second antenna panel 220b may be rotatable. In another example, the first antenna panel 220a or the second antenna panel 220b may be both rotatable and translatable.

As shown in FIG. 3C, example 360 includes a CPE 210. The CPE 210 may be a UE or another type of wireless device. The CPE 210 may include a first antenna panel 220a and a second antenna panel 220b. Other examples may include additional antenna panels.

As further shown in FIG. 3C, the CPE 210 may rotate both antenna panels 220a and 220b (e.g., by rotating a housing including the antenna panels 220a and 220b). Therefore, the CPE 210 may move between different positions of the antenna panels 220a and 220b by rotating the housing.

Example 360 may be combined with example 330, example 300, or both examples 300 and 330. For example, the CPE 210 may rotate the housing, translate the first antenna panel 220a, and rotate the second antenna panel 220b (e.g., by using different motors).

As indicated above, FIGS. 3A-3C are provided as examples. Other examples may differ from what is described with respect to FIGS. 3A-3C. For example, although FIGS. 3A-3C are described in connection with one antenna panel moving relative to another antenna panel, other examples may include multiple antenna panels moving relative to each other. For example, the first antenna panel 220a and the second antenna panel 220b may both be rotated or translated.

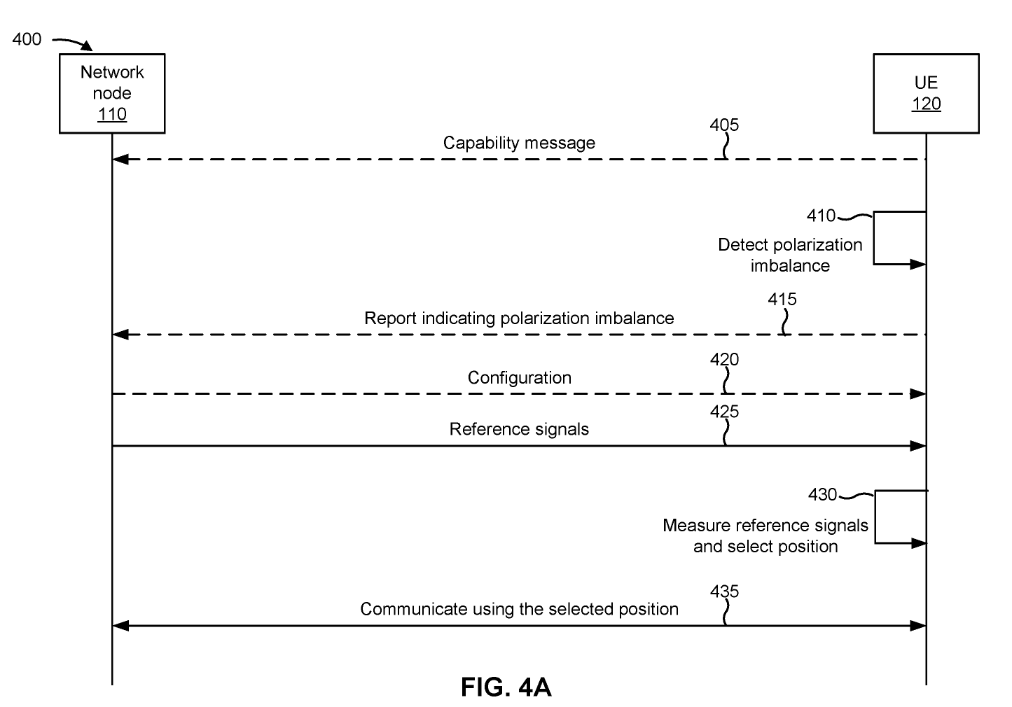

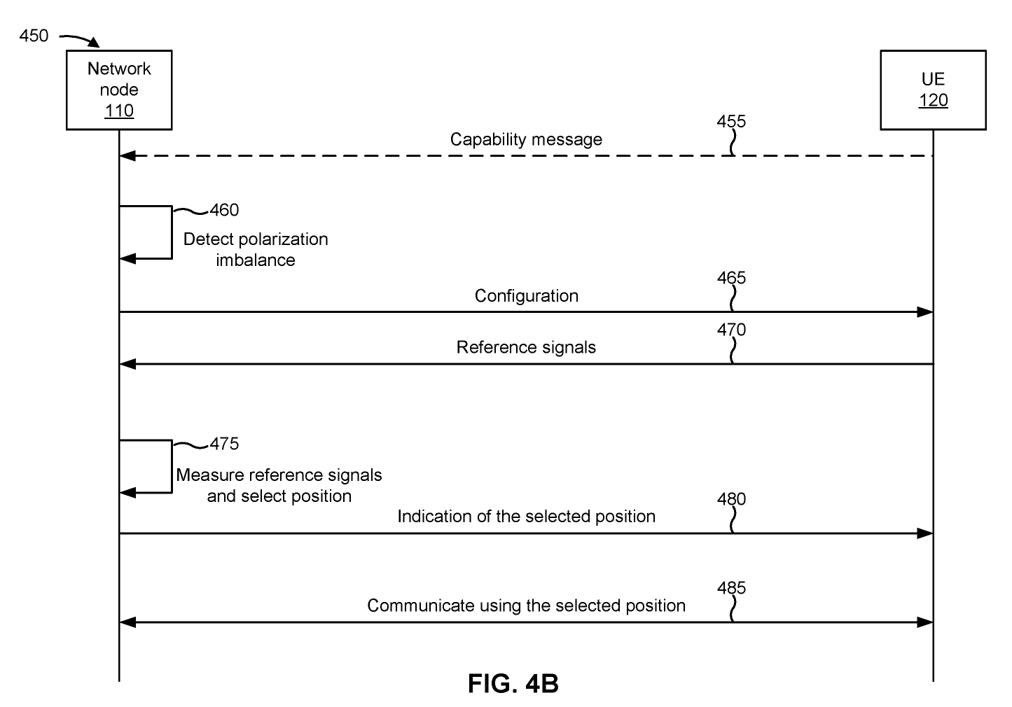

FIG. 4A is a diagram illustrating an example 400 associated with downlink polarization training for moveable antenna arrays. As shown in FIG. 4A, a network node 110 (e.g., an RU or a device controlling the RU, such as a DU or a CU) and a UE 120 may communicate with one another (e.g., OTA in a wireless network, such as the wireless communication network 100 of FIG. 1). Although the example 400 is described in connection with the UE 120, other examples may include a CPE 210 or another type of wireless device instead.

As shown by reference number 405, the UE 120 may transmit, and the network node 110 may receive, a capability message indicating that the UE 120 is able to perform polarization training. For example, the capability message may include a flag, a bit, or another type of indicator associated with an ability to perform polarization training. The UE 120 may transmit, and the network node 110 may receive, the capability message in response to a capability enquiry from the network node 110.

In some aspects, the capability message may further indicate a set of positions associated with a first antenna panel and a second antenna panel of the UE 120. Although described as being indicated in the capability message, the set of positions may be indicated in a separate message (e.g., a report, as described below in connection with reference number 415, or another message). Additionally, or alternatively, the capability message may further indicate a capability associated with one or more motors of the UE 120 that are configured to move the first antenna panel and the second antenna panel. For example, the capability may include a time gap between positions for the first antenna panel and the second antenna panel. Although described as being indicated in the capability message, the time gap (or other capability associated with the motor(s)) may be indicated in a separate message (e.g., a report, as described below in connection with reference number 415, or another message).

In some aspects, the network node 110 may transmit, and the UE 120 may receive, a configuration for a downlink reference signal. For example, the UE 120 may use the downlink reference signal to detect polarization imbalance, as described below in connection with reference number 410. Additionally, or alternatively, the network node 110 may transmit, and the UE 120 may receive, a configuration for a polarization imbalance report. For example, the UE 120 may use resources indicated by the configuration to transmit a report indicating polarization imbalance, as described below in connection with reference number 415.

As shown by reference number 410, the UE 120 may detect a polarization imbalance between the first antenna panel and the second antenna panel. For example, the UE 120 may perform an initial measurement on a downlink reference signal (e.g., an SSB, a CSI-RS, or a DMRS, among other examples) and may determine the polarization imbalance using the initial measurement. For example, the UE 120 may determine the polarization imbalance using a signal strength or an achievable rate difference across polarization layers.

As shown by reference number 415, the UE 120 may transmit, and the network node 110 may receive, a report indicating the polarization imbalance. The report may indicate the initial measurement in the report. In some aspects, the UE 120 may transmit, and the network node 110 may receive, the report in response to the polarization imbalance satisfying a polarization training threshold. For example, the polarization training threshold may be configured by the network node 110 (e.g., by transmitting an indication of the polarization training threshold to the UE 120).

The report may additionally include a request for polarization training. Accordingly, the network node 110 may transmit, and the UE 120 may receive, a configuration for a set of (downlink) reference signals to measure, as shown by reference number 420. The set of reference signals may include an SSB, a CSI-RS, a DMRS, or a combination thereof. The configuration may be based at least in part on the capability associated with the motor(s) of the UE 120 (e.g., the time gap between positions for the first antenna panel and the second antenna panel). Accordingly, a time period between occasions for a reference signal (in the set of reference signals) may be at least as long as the time gap. Additionally, or alternatively, the configuration may be based at least in part on the set of positions indicated by the UE 120. Accordingly, a number of occasions for a reference signal (in the set of reference signals) may be equal to, or greater than, a number of positions in the set of positions.

As shown by reference number 425, the network node 110 may transmit the set of reference signals for the UE 120 to measure. As shown by reference number 430, the UE 120 may perform a set of measurements, on the set of reference signals, corresponding to the set of positions of the first antenna panel relative to the second antenna panel. Accordingly, the UE 120 may move the first antenna panel and the second antenna panel through the set of positions (e.g., using the motor(s)) in order to generate a measurement for each position using the set of reference signals.

The set of reference signals may be indicated by the network node 110 in the configuration. Alternatively, the UE 120 may select the set of reference signals from reference signals that were already configured by the network node 110. The UE 120 may select the set of reference signals using the capability associated with the motor(s) of the UE 120 (e.g., the time gap between positions for the first antenna panel and the second antenna panel). Accordingly, the UE 120 may select the set of reference signals such that a time period, between occasions for a reference signal (in the set of reference signals), is at least as long as the time gap. Additionally, or alternatively, the UE 120 may select the set of positions using the capability associated with the motor(s) of the UE 120 (e.g., the time gap between positions for the first antenna panel and the second antenna panel). Accordingly, the set of positions to be tested may be selected by matching time gaps between successive positions in the set of positions with time periods between successive occasions for reference signals that are available to the UE 120.

Additionally, as further shown by reference number 430, the UE 120 may select a position (from the set of positions) to use. For example, the UE 120 may determine a selected position using the set of measurements. The UE 120 may determine the selected position to minimize (at least locally) a polarization imbalance between the first antenna panel and the second antenna panel.

As shown by reference number 435, the UE 120 and the network node 110 may communicate using the selected position. For example, the UE 120 may move the antenna panels to (or maintain the antenna panels at) the selected position in order to reduce polarization imbalance when communicating with the network node 110.

The polarization training described in connection with FIG. 4A is distinct from beam selection. For example, the UE 120 may perform a subsequent measurement on the downlink reference signal to determine a signal strength imbalance between the first antenna panel and the second antenna panel. The signal strength imbalance (e.g., an overall measurement) is different from the polarization imbalance (e.g., a measurement between polarization layers). Accordingly, the UE 120 may perform a beam search in response to the signal strength imbalance satisfying a beam selection threshold, and the UE 120 may communicate with the network node 110 using a selected beam from the beam search. In some aspects, the UE 120 may transmit an indication of the selected beam to the network node 110.

By using techniques as described in connection with FIG. 4A, the UE 120 may improve quality and reliability of communications with the network node 110 by reducing polarization imbalance between the antenna panels. As a result, the UE 120 conserves power and processing resources that otherwise would have been spent on retransmissions. Additionally, the UE 120 reduces network overhead and congestion by reducing retransmissions.

FIG. 4B is a diagram illustrating an example 450 associated with uplink polarization training for moveable antenna arrays. As shown in FIG. 4B, a network node 110 (e.g., an RU or a device controlling the RU, such as a DU or a CU) and a UE 120 may communicate with one another (e.g., OTA in a wireless network, such as the wireless communication network 100 of FIG. 1). Although the example 450 is described in connection with the UE 120, other examples may include a CPE 210 or another type of wireless device instead.

As shown by reference number 455, the UE 120 may transmit, and the network node 110 may receive, a capability message indicating that the UE 120 is able to perform polarization training. For example, the capability message may include a flag, a bit, or another type of indicator associated with an ability to perform polarization training. The UE 120 may transmit, and the network node 110 may receive, the capability message in response to a capability enquiry from the network node 110.

In some aspects, the capability message may further indicate a set of positions associated with a first antenna panel and a second antenna panel of the UE 120. Although described as being indicated in the capability message, the set of positions may be indicated in a separate message. Additionally, or alternatively, the capability message may further indicate a capability associated with one or more motors of the UE 120 that are configured to move the first antenna panel and the second antenna panel. For example, the capability may include a time gap between positions for the first antenna panel and the second antenna panel. Although described as being indicated in the capability message, the time gap (or other capability associated with the motor(s)) may be indicated in a separate message.

As shown by reference number 460, the network node 110 may detect a polarization imbalance between the first antenna panel and the second antenna panel. For example, the network node may perform an initial measurement on an uplink reference signal (e.g., an SRS or a DMRS, among other examples) and may determine the polarization imbalance using the initial measurement. For example, the network node 110 may determine the polarization imbalance using a signal strength or an achievable rate difference across polarization layers. Alternatively, the network node 110 may use a report from the UE 120 (e.g., indicating one or more measurements on a downlink reference signal) and, assuming channel reciprocity, determine the polarization imbalance using the report.

In response to detecting the polarization imbalance, the network node 110 may transmit, and the UE 120 may receive, a configuration for a set of (uplink) reference signals to transmit, as shown by reference number 465. The set of reference signals may include an SRS or a DMRS, or a combination thereof. The configuration may be based at least in part on the capability associated with the motor(s) of the UE 120 (e.g., the time gap between positions for the first antenna panel and the second antenna panel). Accordingly, a time period between occasions for a reference signal (in the set of reference signals) may be at least as long as the time gap. Additionally, or alternatively, the configuration may be based at least in part on the set of positions indicated by the UE 120. Accordingly, a number of occasions for a reference signal (in the set of reference signals) may be equal to, or greater than, a number of positions in the set of positions.

As shown by reference number 470, the UE 120 may transmit the set of reference signals for the network node 110 to measure. As shown by reference number 475, the network node 110 may perform a set of measurements, on the set of reference signals, corresponding to the set of positions of the first antenna panel relative to the second antenna panel. Accordingly, the UE 120 may move the first antenna panel and the second antenna panel through the set of positions (e.g., using the motor(s)) in order to transmit a reference signal (in the set of reference signals) from each position.

Additionally, as further shown by reference number 475, the network node 110 may select a position (from the set of positions) to use. For example, the network node 110 may determine a selected position using the set of measurements. The network node 110 may determine the selected position to minimize (at least locally) a polarization imbalance between the first antenna panel and the second antenna panel.

As shown by reference number 480, the network node 110 may transmit, and the UE 120 may receive, an indication of the selected position. Accordingly, as shown by reference number 485, the UE 120 and the network node 110 may communicate using the selected position. For example, the UE 120 may move the antenna panels to (or maintain the antenna panels at) the selected position in response to the indication from the network node 110.

The polarization training described in connection with FIG. 4B is distinct from beam selection. For example, the network node 110 may perform a subsequent measurement on the uplink reference signal to determine a signal strength imbalance between the first antenna panel and the second antenna panel. The signal strength imbalance (e.g., an overall measurement) is different from the polarization imbalance (e.g., a measurement between polarization layers). Accordingly, the network node 110 may select a new beam in response to the signal strength imbalance satisfying a beam selection threshold, and the network node 110 may indicate the new beam to the UE 120. Accordingly, the network node 110 may communicate with the UE 120 using the new beam.

By using techniques as described in connection with FIG. 4B, the network node 110 may improve quality and reliability of communications with the UE 120 by reducing polarization imbalance between the antenna panels. As a result, the network node 110 conserves power and processing resources that otherwise would have been spent on retransmissions. Additionally, the network node 110 reduces network overhead and congestion by reducing retransmissions.

As indicated above, FIGS. 4A-4B are provided as examples. Other examples may differ from what is described with respect to FIGS. 4A-4B.

FIG. 5 is a diagram illustrating an example process 500 performed, for example, at a wireless device or an apparatus of a wireless device. Example process 500 is an example where the apparatus or the wireless device (e.g., UE 120) performs operations associated with polarization training for moveable antenna panels.

As shown in FIG. 5, in some aspects, process 500 may include receiving a set of reference signals corresponding to a set of positions of a first antenna panel relative to a second antenna panel (block 510). For example, the wireless device (e.g., using reception component 802 or communication manager 806, depicted in FIG. 8) may receive a set of reference signals corresponding to a set of positions of a first antenna panel relative to a second antenna panel, as described herein.

As further shown in FIG. 5, in some aspects, process 500 may include obtaining a set of measurements on the set of reference signals in response to a polarization imbalance between the first antenna panel and the second antenna panel satisfying a polarization training threshold, the polarization imbalance based on a downlink reference signal (block 520). For example, the wireless device (e.g., using reception component 802 or communication manager 806) may obtain a set of measurements on the set of reference signals in response to a polarization imbalance between the first antenna panel and the second antenna panel satisfying a polarization training threshold, the polarization imbalance based on a downlink reference signal, as described herein.

As further shown in FIG. 5, in some aspects, process 500 may include communicating, with a network node, using a selected position from the set of positions, the selected position being determined using the set of measurements (block 530). For example, the wireless device (e.g., using reception component 802, transmission component 804, or communication manager 806, depicted in FIG. 8) may communicate, with a network node, using a selected position from the set of positions, the selected position being determined using the set of measurements, as described herein.

Process 500 may include additional aspects, such as any single aspect or any combination of aspects described below or in connection with one or more other processes described elsewhere herein.

In a first aspect, the polarization imbalance is determined using a signal strength or a rate difference across polarization layers.

In a second aspect, alone or in combination with the first aspect, the set of reference signals includes an SSB, a CSI-RS, a DMRS, or a combination thereof.

In a third aspect, alone or in combination with one or more of the first and second aspects, one or more motors of the wireless device are configured to move the first antenna panel, the second antenna panel, or a combination thereof, to each position in the set of positions.

In a fourth aspect, alone or in combination with one or more of the first through third aspects, the set of reference signals are selected using a capability associated with the one or more motors.

In a fifth aspect, alone or in combination with one or more of the first through fourth aspects, the set of positions are selected using a capability associated with the one or more motors.

In a sixth aspect, alone or in combination with one or more of the first through fifth aspects, process 500 includes determining (e.g., using reception component 802 or communication manager 806) a signal strength imbalance between the first antenna panel of the wireless device and the second antenna panel of the wireless device, the signal strength imbalance based on the downlink reference signal; performing a beam search (e.g., using reception component 802 or communication manager 806) in response to the signal strength imbalance satisfying a beam selection threshold; and communicating (e.g., using reception component 802, transmission component 804, or communication manager 806), with the network node, using a selected beam from the beam search.

In a seventh aspect, alone or in combination with one or more of the first through sixth aspects, the wireless device includes a CPE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE or an apparatus of a UE. Example process 600 is an example where the apparatus or the UE (e.g., UE 120) performs operations associated with polarization training for moveable antenna panels.

As shown in FIG. 6, in some aspects, process 600 may include transmitting a report indicating a polarization imbalance between a first antenna panel and a second antenna panel, where the first antenna panel and the second antenna panel are moveable relative to each other (block 610). For example, the UE (e.g., using transmission component 804 or communication manager 806, depicted in FIG. 8) may transmit a report indicating a polarization imbalance between a first antenna panel and a second antenna panel, where the first antenna panel and the second antenna panel are moveable relative to each other, as described herein.

As further shown in FIG. 6, in some aspects, process 600 may include receiving, in response to the report, a configuration for a set of downlink reference signals to measure (block 620). For example, the UE (e.g., using reception component 802 or communication manager 806, depicted in FIG. 8) may receive, in response to the report, a configuration for a set of downlink reference signals to measure, as described herein.

As further shown in FIG. 6, in some aspects, process 600 may include performing a set of measurements on the set of downlink reference signals, where the set of measurements are used to determine a selected position for the first antenna panel and the second antenna panel (block 630). For example, the UE (e.g., using reception component 802 or communication manager 806) may perform a set of measurements on the set of downlink reference signals, where the set of measurements are used to determine a selected position for the first antenna panel and the second antenna panel, as described herein.

Process 600 may include additional aspects, such as any single aspect or any combination of aspects described below or in connection with one or more other processes described elsewhere herein.

In a first aspect, process 600 includes receiving an indication of a polarization training threshold, the report is transmitted in response to the polarization imbalance satisfying the polarization training threshold.

In a second aspect, alone or in combination with the first aspect, process 600 includes transmitting (e.g., using transmission component 804 or communication manager 806) an indication of a set of positions from which the selected position will be determined.

In a third aspect, alone or in combination with one or more of the first and second aspects, process 600 includes transmitting (e.g., using transmission component 804 or communication manager 806) an indication of a time gap between positions for the first antenna panel and the second antenna panel.

In a fourth aspect, alone or in combination with one or more of the first through third aspects, process 600 includes receiving (e.g., using reception component 802 or communication manager 806) an instruction to perform polarization training, in response to an uplink rate imbalance across polarization layers, and a configuration for a set of reference signals to transmit; transmitting (e.g., using transmission component 804 or communication manager 806) the set of uplink reference signals, where each reference signal in the set of uplink reference signals is associated with a different position, from a set of positions, for the first antenna panel and the second antenna panel; and receiving (e.g., using reception component 802 or communication manager 806) an indication of a selected position, from the set of positions, to use for uplink.

In a fifth aspect, alone or in combination with one or more of the first through fourth aspects, process 600 includes performing a beam search (e.g., using reception component 802 or communication manager 806) in response to a signal strength imbalance between the first antenna panel of the UE and the second antenna panel satisfying a beam selection threshold, and transmitting (e.g., using transmission component 804 or communication manager 806) an indication of a selected beam from the beam search.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with polarization training for moveable antenna panels.

As shown in FIG. 7, in some aspects, process 700 may include receiving a report indicating a polarization imbalance between a first antenna panel of a UE and a second antenna panel of the UE, where the first antenna panel and the second antenna panel are moveable relative to each other (block 710). For example, the network node (e.g., using reception component 902 or communication manager 906, depicted in FIG. 9) may receive a report indicating a polarization imbalance between a first antenna panel of a UE and a second antenna panel of the UE, where the first antenna panel and the second antenna panel are moveable relative to each other, as described herein.

As further shown in FIG. 7, in some aspects, process 700 may include transmitting, in response to the report, a configuration for a set of downlink reference signals (block 720). For example, the network node (e.g., using transmission component 904 or communication manager 906, depicted in FIG. 9) may transmit, in response to the report, a configuration for a set of downlink reference signals, as described herein.

As further shown in FIG. 7, in some aspects, process 700 may include transmitting the set of downlink reference signals for measurement by the UE to determine a selected position for the first antenna panel and the second antenna panel (block 730). For example, the network node (e.g., using transmission component 904 or communication manager 906) may transmit the set of downlink reference signals for measurement by the UE to determine a selected position for the first antenna panel and the second antenna panel, as described herein.

Process 700 may include additional aspects, such as any single aspect or any combination of aspects described below or in connection with one or more other processes described elsewhere herein.

In a first aspect, process 700 includes transmitting an indication of a polarization training threshold, the report is received in response to the polarization imbalance satisfying the polarization training threshold.

In a second aspect, alone or in combination with the first aspect, process 700 includes receiving (e.g., using reception component 902 or communication manager 906) an indication of a set of positions from which the selected position will be determined.

In a third aspect, alone or in combination with one or more of the first and second aspects, process 700 includes receiving (e.g., using reception component 902 or communication manager 906) an indication of a time gap between positions for the first antenna panel and the second antenna panel, where the set of downlink reference signals are scheduled based at least in part on the time gap.

In a fourth aspect, alone or in combination with one or more of the first through third aspects, process 700 includes transmitting (e.g., using transmission component 904 or communication manager 906) an instruction to perform polarization training, in response to an uplink rate imbalance across polarization layers, and a configuration for a set of uplink reference signals; performing a set of measurements (e.g., using reception component 902 or communication manager 906) on the set of uplink reference signals, where each reference signal in the set of uplink reference signals is associated with a different position, from a set of positions, for the first antenna panel of the UE and the second antenna panel of the UE; and transmitting (e.g., using transmission component 904 or communication manager 906) an indication of a selected position, from the set of positions, based at least in part on the set of measurements.

In a fifth aspect, alone or in combination with one or more of the first through fourth aspects, process 700 includes receiving (e.g., using reception component 902 or communication manager 906) an indication of a selected beam from a beam search by the UE triggered by a signal strength imbalance between the first antenna panel of the UE and the second antenna panel of the UE satisfying a beam selection threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 3A-3C or 4A-4B. Additionally, or alternatively, the apparatus 800 may be configured to perform one or more processes described herein, such as process 500 of FIG. 5, process 600 of FIG. 6, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

In some aspects, the reception component 802 may receive a set of reference signals corresponding to a set of positions of a first antenna panel of the apparatus 800 relative to a second antenna panel of the apparatus 800. The reception component 802 may obtain a set of measurements on the set of reference signals in response to a polarization imbalance (e.g., based on a downlink reference signal) between the first antenna panel and the second antenna panel satisfying a polarization training threshold. The reception component 802 and the transmission component 804 may communicate (e.g., with the apparatus 808) using a selected position from the set of positions, where the selected position is determined using the set of measurements.

In some aspects, the reception component 802 may determine a signal strength imbalance between the first antenna panel and the second antenna panel (e.g., based on the downlink reference signal). Accordingly, the reception component 802 may perform a beam search in response to the signal strength imbalance satisfying a beam selection threshold. In some aspects, the transmission component 804 may transmit (e.g., to the apparatus 808) an indication of a selected beam from the beam search.

In some aspects, the transmission component 804 may transmit (e.g., to the apparatus 808) a report indicating the polarization imbalance between the first antenna panel and the second antenna panel, which are moveable relative to each other. The reception component 802 may receive (e.g., from the apparatus 808), in response to the report, a configuration for the set of reference signals to measure. Therefore, the reception component 802 may perform the set of measurements on the set of reference signals (in response to the configuration), where the set of measurements are used to determine the selected position.

In some aspects, the reception component 802 may receive (e.g., from the apparatus 808) an indication of the polarization training threshold, such that the transmission component 804 transmits the report in response to the polarization imbalance satisfying the polarization training threshold.

In some aspects, the transmission component 804 may transmit (e.g., to the apparatus 808) an indication of the set of positions from which the selected position will be determined. Additionally, or alternatively, the transmission component 804 may transmit (e.g., to the apparatus 808) an indication of a time gap between positions for the first antenna panel and the second antenna panel.

In some aspects, the reception component 802 may receive (e.g., from the apparatus 808) an instruction to perform polarization training, in response to an uplink rate imbalance across polarization layers, and a configuration for a set of reference signals to transmit. Accordingly, the transmission component 804 may transmit (e.g., to the apparatus 808) the set of uplink reference signals, where each reference signal in the set of uplink reference signals is associated with a different position, from a set of positions, for the first antenna panel and the second antenna panel. The reception component 802 may receive (e.g., from the apparatus 808) an indication of a selected position, from the set of positions, to use for uplink.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4A-4B. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

In some aspects, the reception component 902 may receive (e.g., from the apparatus 908) a report indicating a polarization imbalance between a first antenna panel of the apparatus 908 and a second antenna panel of the apparatus 908, where the first antenna panel and the second antenna panel are moveable relative to each other. Accordingly, the transmission component 904 may transmit (e.g., to the apparatus 908), in response to the report, a configuration for a set of downlink reference signals. Additionally, the transmission component 904 may transmit (e.g., to the apparatus 908) the set of downlink reference signals for measurement by the apparatus 908 to determine a selected position for the first antenna panel and the second antenna panel.

In some aspects, the transmission component 904 may transmit (e.g., to the apparatus 908) an indication of a polarization training threshold. Therefore, the reception component 902 may receive the report in response to the polarization imbalance satisfying the polarization training threshold. In some aspects, the reception component 902 may receive (e.g., from the apparatus 908) an indication of a set of positions from which the selected position will be determined. Additionally, or alternatively, the reception component 902 may receive (e.g., from the apparatus 908) an indication of a time gap between positions for the first antenna panel and the second antenna panel, where the set of downlink reference signals are scheduled based at least in part on the time gap. For example, the set of downlink signals may be scheduled to enable the apparatus 908 to move the first antenna panel relative to the second antenna panel.

In some aspects, the transmission component 904 may transmit (e.g., to the apparatus 908) an instruction to perform polarization training, in response to an uplink rate imbalance across polarization layers, and a configuration for a set of uplink reference signals. The reception component 902 may perform a set of measurements on the set of uplink reference signals, where each reference signal in the set of uplink reference signals is associated with a different position, from a set of positions, for the first antenna panel of the apparatus 908 and the second antenna panel of the apparatus 908. Accordingly, the transmission component 904 may transmit (e.g., to the apparatus 908) an indication of a selected position, from the set of positions, based at least in part on the set of measurements.

In some aspects, the reception component 902 may receive (e.g., from the apparatus 908) an indication of a selected beam from a beam search by the apparatus 908 triggered by a signal strength imbalance between the first antenna panel of the apparatus 908 and the second antenna panel of the apparatus 908 satisfying a beam selection threshold.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless device, comprising: receiving a set of reference signals corresponding to a set of positions of a first antenna panel of the wireless device relative to a second antenna panel of the wireless device; obtaining obtain a set of measurements on the set of reference signals in response to a polarization imbalance between the first antenna panel and the second antenna panel satisfying a polarization training threshold, the polarization imbalance based on a downlink reference signal; and communicating, with a network node, using a selected position from the set of positions, wherein the selected position is determined using the set of measurements.

Aspect 2: The method of Aspect 1, wherein the polarization imbalance is determined using a signal strength or a rate difference across polarization layers.

Aspect 3: The method of any of Aspects 1-2, wherein the set of reference signals comprise a synchronization signal block (SSB), a channel state information reference signal (CSI-RS), a demodulation reference signal (DMRS), or a combination thereof.

Aspect 4: The method of any of Aspects 1-3, wherein one or more motors are configured to move the first antenna panel, the second antenna panel, or a combination thereof, to each position in the set of positions.

Aspect 5: The method of Aspect 4, wherein the set of reference signals are selected using a capability associated with the one or more motors.

Aspect 6: The method of any of Aspects 4-5, wherein the set of positions are selected using a capability associated with the one or more motors.

Aspect 7: The method of any of Aspects 1-6, further comprising: performing a subsequent measurement on the downlink reference signal to determine a signal strength imbalance between the first antenna panel of the wireless device and the second antenna panel of the wireless device; performing a beam search in response to the signal strength imbalance satisfying a beam selection threshold; and communicating, with the network node, using a selected beam from the beam search.

Aspect 8: The method of any of Aspects 1-7, wherein the wireless device comprises a customer premises equipment (CPE).

Aspect 9: A method of wireless communication performed by a user equipment (UE), comprising: transmitting a report indicating a polarization imbalance between a first antenna panel of the UE and a second antenna panel of the UE, wherein the first antenna panel and the second antenna panel are moveable relative to each other; receiving, in response to the report, a configuration for a set of downlink reference signals to measure; and performing a set of measurements on the set of downlink reference signals, wherein the set of measurements are used to determine a selected position for the first antenna panel and the second antenna panel.

Aspect 10: The method of Aspect 9, further comprising: receiving an indication of a polarization training threshold, wherein the report is transmitted in response to the polarization imbalance satisfying the polarization training threshold.

Aspect 11: The method of any of Aspects 9-10, further comprising: transmitting an indication of a set of positions from which the selected position will be determined.

Aspect 12: The method of any of Aspects 9-11, further comprising: transmitting an indication of a time gap between positions for the first antenna panel and the second antenna panel.

Aspect 13: The method of any of Aspects 9-12, further comprising: receiving an instruction to perform polarization training, in response to an uplink rate imbalance across polarization layers, and a configuration for a set of reference signals to transmit; transmitting the set of uplink reference signals, wherein each reference signal in the set of uplink reference signals is associated with a different position, from a set of positions, for the first antenna panel and the second antenna panel; and receiving an indication of a selected position, from the set of positions, to use for uplink.

Aspect 14: The method of any of Aspects 9-13, further comprising: performing a beam search in response to a signal strength imbalance between the first antenna panel of the UE and the second antenna panel of the UE satisfying a beam selection threshold; and transmitting an indication of a selected beam from the beam search.

Aspect 15: A method of wireless communication performed by a network node, comprising: receiving a report indicating a polarization imbalance between a first antenna panel of a user equipment (UE) and a second antenna panel of the UE, wherein the first antenna panel and the second antenna panel are moveable relative to each other; transmitting, in response to the report, a configuration for a set of downlink reference signals; and transmitting the set of downlink reference signals for measurement by the UE to determine a selected position for the first antenna panel and the second antenna panel.

Aspect 16: The method of Aspect 15, further comprising: transmitting an indication of a polarization training threshold, wherein the report is received in response to the polarization imbalance satisfying the polarization training threshold.

Aspect 17: The method of any of Aspects 15-16, further comprising: receiving an indication of a set of positions from which the selected position will be determined.

Aspect 18: The method of any of Aspects 15-17, further comprising: receiving an indication of a time gap between positions for the first antenna panel and the second antenna panel, wherein the set of downlink reference signals are scheduled based at least in part on the time gap.

Aspect 19: The method of any of Aspects 15-18, further comprising: transmitting an instruction to perform polarization training, in response to an uplink rate imbalance across polarization layers, and a configuration for a set of uplink reference signals; performing a set of measurements on the set of uplink reference signals, wherein each reference signal in the set of uplink reference signals is associated with a different position, from a set of positions, for the first antenna panel of the UE and the second antenna panel of the UE; and transmitting an indication of a selected position, from the set of positions, based at least in part on the set of measurements.

Aspect 20: The method of any of Aspects 15-19, further comprising: receiving an indication of a selected beam from a beam search by the UE triggered by a signal strength imbalance between the first antenna panel of the UE and the second antenna panel of the UE satisfying a beam selection threshold.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A wireless device, comprising:
a first antenna panel;
a second antenna panel; and
processing system that includes one or more processors and one or more code-storing memories coupled with the one or more processors, the processing system configured to cause the wireless device to:
receive a set of reference signals corresponding to a set of positions of the first antenna panel relative to the second antenna panel;
obtain a set of measurements on the set of reference signals in response to a polarization imbalance between the first antenna panel and the second antenna panel satisfying a polarization training threshold, the polarization imbalance based on a downlink reference signal; and
communicate, with a network node, using a selected position from the set of positions, wherein the selected position is determined using the set of measurements.

2. The wireless device of claim 1, wherein the polarization imbalance is determined using a signal strength or a rate difference across polarization layers.

3. The wireless device of claim 1, wherein the set of reference signals comprise a synchronization signal block (SSB), a channel state information reference signal (CSI-RS), a demodulation reference signal (DMRS), or a combination thereof.

4. The wireless device of claim 1, further comprising:
one or more motors configured to move the first antenna panel, the second antenna panel, or a combination thereof, to each position in the set of positions.

5. The wireless device of claim 4, wherein the set of reference signals are selected using a capability associated with the one or more motors.

6. The wireless device of claim 4, wherein the set of positions are selected using a capability associated with the one or more motors.

7. The wireless device of claim 1, wherein the processing system is configured to cause the wireless device to:
determine a signal strength imbalance between the first antenna panel of the wireless device and the second antenna panel of the wireless device, the signal strength imbalance based on the downlink reference signal;
perform a beam search in response to the signal strength imbalance satisfying a beam selection threshold; and
communicate, with the network node, using a selected beam from the beam search.

8. The wireless device of claim 1, wherein the wireless device comprises a customer premises equipment (CPE).

9. A user equipment (UE), comprising:
a first antenna panel;
a second antenna panel; and
a processing system that includes one or more processors and one or more code-storing memories coupled with the one or more processors, the processing system configured to cause the UE to:
transmit a report indicating a polarization imbalance between the first antenna panel of the UE and the second antenna panel of the UE, wherein the first antenna panel and the second antenna panel are moveable relative to each other;
receive, in response to the report, a configuration for a set of downlink reference signals to measure; and
perform a set of measurements on the set of downlink reference signals, wherein the set of measurements are used to determine a selected position for the first antenna panel and the second antenna panel.

10. The UE of claim 9, wherein the processing system is configured to cause the UE to:
receive an indication of a polarization training threshold,
wherein the report is transmitted in response to the polarization imbalance satisfying the polarization training threshold.

11. The UE of claim 9, wherein the processing system is configured to cause the UE to:
transmit an indication of a set of positions from which the selected position will be determined.

12. The UE of claim 9, wherein the processing system is configured to cause the UE to:
transmit an indication of a time gap between positions for the first antenna panel and the second antenna panel.

13. The UE of claim 9, wherein the processing system is configured to cause the UE to:
receive an instruction to perform polarization training, in response to an uplink rate imbalance across polarization layers, and a configuration for a set of reference signals to transmit;
transmit the set of uplink reference signals, wherein each reference signal in the set of uplink reference signals is associated with a different position, from a set of positions, for the first antenna panel and the second antenna panel; and
receive an indication of a selected position, from the set of positions, to use for uplink.

14. The UE of claim 9, wherein the processing system is configured to cause the UE to:
perform a beam search in response to a signal strength imbalance between the first antenna panel of the UE and the second antenna panel of the UE satisfying a beam selection threshold; and
transmit an indication of a selected beam from the beam search.

15. A network node, comprising:
a processing system that includes one or more processors and one or more code-storing memories coupled with the one or more processors, the processing system configured to cause the network node to:
receive a report indicating a polarization imbalance between a first antenna panel of a user equipment (UE) and a second antenna panel of the UE, wherein the first antenna panel and the second antenna panel are moveable relative to each other;
transmit, in response to the report, a configuration for a set of downlink reference signals; and
transmit the set of downlink reference signals for measurement by the UE to determine a selected position for the first antenna panel and the second antenna panel.

16. The network node of claim 15, wherein the processing system is configured to cause the network node to:
transmit an indication of a polarization training threshold,
wherein the report is received in response to the polarization imbalance satisfying the polarization training threshold.

17. The network node of claim 15, wherein the processing system is configured to cause the network node to:
receive an indication of a set of positions from which the selected position will be determined.

18. The network node of claim 15, wherein the processing system is configured to cause the network node to:
receive an indication of a time gap between positions for the first antenna panel and the second antenna panel,
wherein the set of downlink reference signals are scheduled based at least in part on the time gap.

19. The network node of claim 15, wherein the processing system is configured to cause the network node to:
transmit an instruction to perform polarization training, in response to an uplink rate imbalance across polarization layers, and a configuration for a set of uplink reference signals;
perform a set of measurements on the set of uplink reference signals, wherein each reference signal in the set of uplink reference signals is associated with a different position, from a set of positions, for the first antenna panel of the UE and the second antenna panel of the UE; and
transmit an indication of a selected position, from the set of positions, based at least in part on the set of measurements.

20. The network node of claim 15, wherein the processing system is configured to cause the network node to:
receive an indication of a selected beam from a beam search by the UE triggered by a signal strength imbalance between the first antenna panel of the UE and the second antenna panel of the UE satisfying a beam selection threshold.
